(19) United States
(12) Patent Application Publication
(10) Pub. No.: US 2008/0161145 A1
(43) Pub. Date: Jul. 3, 2008

(54) BICYCLE CHAIN WHEEL WITH FASTENER COVER

(75) Inventors: Shingo SHIRAISHI, Osaka (JP); Masahiro YAMANAKA, Osaka (JP); Yusuke NISHIMOTO, Osaka (JP)

Correspondence Address: GLOBAL IP COUNSELORS, LLP, 1233 20TH STREET, NW, SUITE 700, WASHINGTON, DC, 20036-2680, US

(73) Assignee: SHIMANO INC., Osaka (JP)

(21) Appl. No.: 11/745,612

(22) Filed: May 8, 2007

Related U.S. Application Data
(63) Continuation-in-part of application No. 11/646,441, filed on Dec. 28, 2006.

(51) Int. Cl. B62J 13/02

(52) U.S. Cl. 474/145

(57) ABSTRACT

A bicycle chain wheel assembly is provided with a chainring mounting structure, at least one chainring, a plurality of fasteners and a plurality of fastener covering structures. The chainring mounting structure has an exterior facing side and an interior facing side with a plurality of chainring mounting openings on the exterior facing side. The chainring overlies one of the exterior and interior facing sides of the chainring mounting structure. The fasteners secure the chainring to the chainring mounting structure via the chainring mounting openings. The fastener covering structures overlie exterior portions of the fasteners to conceal the fasteners from view when viewed from the exterior facing side of the chainring mounting structure.

### CROSS-REFERENCE TO RELATED APPLICATIONS

This application is a continuation-in-part application of U.S. patent application Ser. No. 11/646,441, filed on Dec. 28, 2006. The entire disclosure of U.S. patent application Ser. No. 11/646,441 is hereby incorporated herein by reference.

### BACKGROUND OF THE INVENTION

1. Field of the Invention

The present invention generally relates to a bicycle chain wheel for a bicycle. More specifically, the present invention relates to a fastener cover for fasteners that attach a chainring to a bicycle chainring support structure.

2. Background Information

Bicycling is becoming an increasingly more popular form of recreation as well as a means of transportation. Moreover, bicycling has become a very popular competitive sport for both amateurs and professionals. Whether the bicycle is used for recreation, transportation or competition, the bicycle industry is constantly improving the various components of the bicycle to make the bicycle easier to assemble and more affordable to purchase and maintain.

One particular portion of a bicycle that has been extensively redesigned over the past years is the drive train of the bicycle. A bicycle drive train typically has a chain that interconnects one or more front gears (chainrings) to one or more sprockets mounted on the rear wheel. The front chainrings are mounted on the bicycle frame by a bottom bracket that has a crank arm axle that rotates relative to the bicycle frame. Each end of the crank arm axle has a crank arm fixed thereto for rotating the crank arm axle relative to the bicycle frame. The crank arms extend outwardly from the bottom bracket in opposite directions and have pedals attached to their free ends for supporting the rider's feet. The front chainrings are typically attached to the right crank arm to rotate therewith. Rotation of the pedals by the rider causes the chainrings to rotate which in turn moves the bicycle chain to rotate the rear sprockets, and thus, rotate the rear wheel of the bicycle.

With a bicycle having a front chain wheel such as described above, sometimes one or more of the front gears or chainrings are attached to a spider of the crank arm by using chainring fasteners (e.g., nuts and bolts). These chainring fasteners are sometimes visible on the exterior side of the chain wheel. Often, over a period of time, dirt may collect in the chainring fasteners which will detract from the overall appearance of the chain wheel.

In view of the above, it will be apparent to those skilled in the art from this disclosure that there exists a need for a bicycle chain wheel with a fastener cover that covers a fastener that is used to attach the front gears or chainrings to the spider of the crank arm. This invention addresses this need in the art as well as other needs, which will become apparent to those skilled in the art from this disclosure.

### SUMMARY OF THE INVENTION

One object of the present invention is to provide a bicycle chain wheel with one or more fastener covers that overlie a fastener that connects one or more of front gears or chainrings to a spider.

Another object of the present invention is to provide a fastener cover structure that can be used with existing types of bicycle chain wheels.

The foregoing objects can basically be attained by providing a bicycle chain wheel assembly in accordance with a first aspect of the present invention that basically comprises a chainring mounting structure, at least one chainring, at least one fastener and at least one fastener covering structure. The chainring mounting structure includes an exterior facing side and an interior facing side with at least one chainring mounting opening on the exterior facing side. The chainring overlies one of the exterior and interior facing sides of the chainring mounting structure. The fastener is coupled to the at least one chainring mounting opening to secure the chainring to the chainring mounting structure. The fastener covering structure overlies an exterior portion of the fastener to conceal the fastener from view when viewed from the exterior facing side of the chainring mounting structure.

In accordance with a second aspect of the present invention, a bicycle chain wheel fastening arrangement is provide that basically comprises a fixing nut, a fixing bolt and a fastener covering structure. The fixing nut includes an internally threaded bore. The fixing bolt includes an externally threaded shaft with an axially extending internal passage that coaxially aligns with the internally threaded bore of the fixing nut when the externally threaded shaft of the fixing bolt is threaded in the internally threaded bore of the fixing nut. The fastener covering structure includes coupling portion engaging one of the fixing nut and the fixing bolt, and a cover portion overlying an exterior portion of one of the fixing nut and the fixing bolt to conceal the fastener.

These and other objects, features, aspects and advantages of the present invention will become apparent to those skilled in the art from the following detailed description, which, taken in conjunction with the annexed drawings, discloses preferred embodiments of the present invention.

### BRIEF DESCRIPTION OF THE DRAWINGS

Referring now to the attached drawings which form a part of this original disclosure:

FIG. 1 is a side elevational view of a bicycle equipped with a bicycle chain wheel equipped with a fastener cover structure including a plurality of fastener covers in accordance with one preferred embodiment of the present invention;

FIG. 2 is an enlarged outside elevational view of the bicycle chain wheel with the fastener covers illustrated in FIG. 1 in accordance with the present invention;

FIG. 3 is an outside elevational view of the bicycle chain wheel illustrated in FIG. 2 after the fastener covers have been removed;

FIG. 4 is a rear elevational view of the bicycle chain wheel illustrated in FIGS. 1-3 in accordance with the present invention;

FIG. 5 is an enlarged cross sectional view of the bicycle chain wheel as seen along section line 5-5 of FIG. 2;

FIG. 6 is an exploded cross sectional view of the bicycle chain wheel illustrated in FIG. 5 in accordance with the present invention;

FIG. 7 is an axial end view of one of the fixing nuts for the bicycle chain wheel illustrated in FIGS. 1-6;

FIG. 8 is a side view of one of the fixing nuts for the bicycle chain wheel illustrated in FIGS. 1-6;

FIG. 9 is an axial end view of one of the fixing bolts for the bicycle chain wheel illustrated in FIGS. 1-6;

FIG. 10 is a side view of one of the fixing bolts for the bicycle chain wheel illustrated in FIGS. 1-6;

FIG. 11 is a side edge view of one of the fastener covers for the bicycle chain wheel illustrated in FIGS. 1-6;

FIG. 12 is an exterior side view of one of the fastener covers for the bicycle chain wheel illustrated in FIGS. 1-6;

FIG. 13 is an interior side view of one of the fastener covers for the bicycle chain wheel illustrated in FIGS. 1-6;

FIG. 14 is a bottom edge view of one of the fastener covers for the bicycle chain wheel illustrated in FIGS. 1-6;

FIG. 15 is an interior side view of one of the fastener covers for the bicycle chain wheel illustrated in FIGS. 1-6;

FIG. 16 is an enlarged cross sectional view, similar to FIG. 5, of a bicycle chain wheel in accordance with an alternative embodiment of the present invention;

FIG. 17 is an enlarged outside elevational view of the bicycle chain wheel with a chain guard that includes a fastener cover structure in accordance with another alternative embodiment of the present invention;

FIG. 18 is a rear elevational view of the bicycle chain wheel illustrated in FIG. 17 in accordance with the alternative embodiment of the present invention;

FIG. 19 is an enlarged cross sectional view of the bicycle chain wheel as seen along section line 19-19 of FIG. 17 in accordance with the alternative embodiment of the present invention;

FIG. 20 is an exploded cross sectional view of the bicycle chain wheel illustrated in FIG. 19 in accordance with the alternative embodiment of the present invention; and

FIG. 21 is an enlarged inside elevational view of the chain guard that includes the fastener cover structure illustrated in FIGS. 17 to 19 in accordance with another alternative embodiment of the present invention.

### DETAILED DESCRIPTION OF THE PREFERRED EMBODIMENTS

Selected embodiments of the present invention will now be explained with reference to the drawings. It will be apparent to those skilled in the art from this disclosure that the following descriptions of the embodiments of the present invention are provided for illustration only and not for the purpose of limiting the invention as defined by the appended claims and their equivalents.

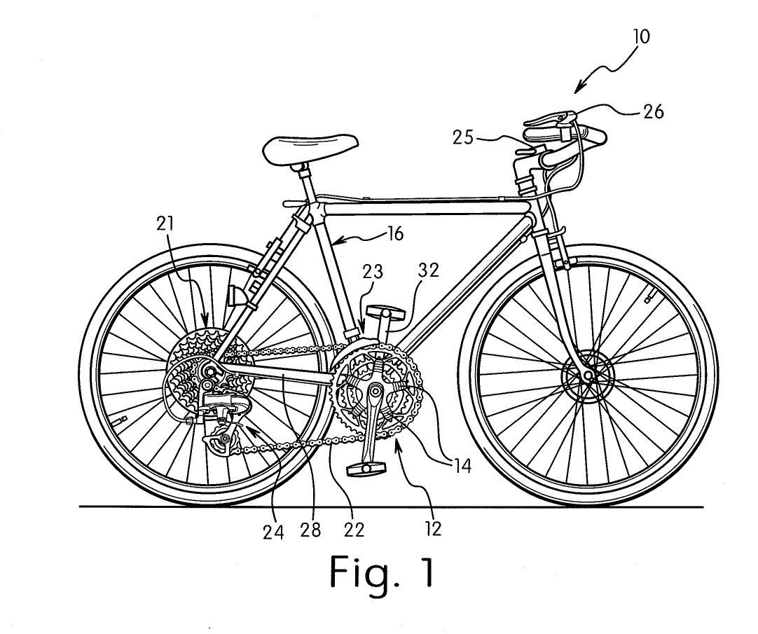

Referring initially to FIG. 1, a bicycle 10 is illustrated that is equipped with a bicycle chain wheel assembly 12 with a fastener covering structure 14 in accordance with one embodiment of the present invention. As will become apparent form the description of the fastener covering structure 14 discussed below, the fastener covering structure 14 provides the bicycle chain wheel assembly 12. Since the bicycle chain wheel assembly 12 relates to a bicycle drive train, the parts of the bicycle drive train will be briefly discussed. The other parts of the bicycle 10 are conventional, and thus, will not be discussed and/or illustrated in detail herein.

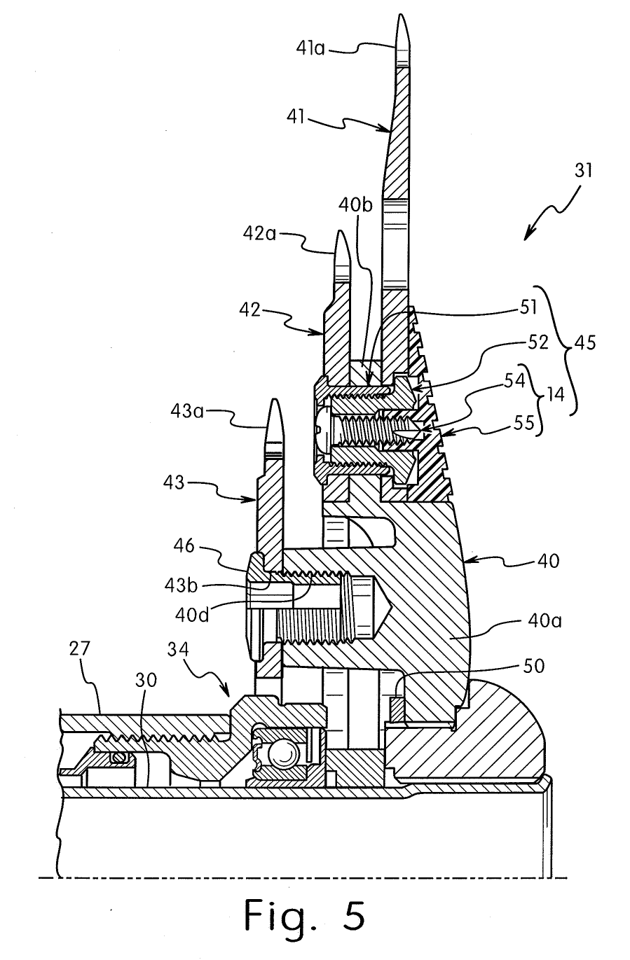

The bicycle chain wheel assembly 12 is mounted to a bicycle frame 16 in a conventional manner. In addition to the bicycle chain wheel assembly 12, the bicycle drive train basically includes a rear cassette or sprocket assembly 21, a chain 22, a front derailleur 23 and a rear derailleur 24. The chain 22 is shifted by a rider selectively operating a pair of shift operating devices 25 and 26 in a conventional manner to actuate the derailleurs 23 and 24. The bicycle chain wheel assembly 12 is rotatably mounted to a hanger tube 27 (FIG. 5) located at a lower part of the frame 16, while the rear cassette 21 is rotatably mounted to a pair of seat stays 28 (FIG. 1) of the frame 16.

As shown in FIGS. 1 and 5, the bicycle chain wheel assembly 12 basically includes a crank axle 30 (FIG. 5), a bicycle chain wheel assembly or right crankset 31 and a left crank arm 32 (FIG. 1). The crank axle 30 is supported in a freely rotatable manner in the hanger tube 27 of the frame 16 in a conventional manner by a bottom bracket 34. The bicycle chain wheel assembly or right crankset 31 is fastened onto a right end of the crank axle 30 by crimping. The left crank arm 32 (FIG. 1) is fastened in a detachable manner to the left end of the crankshaft 30.

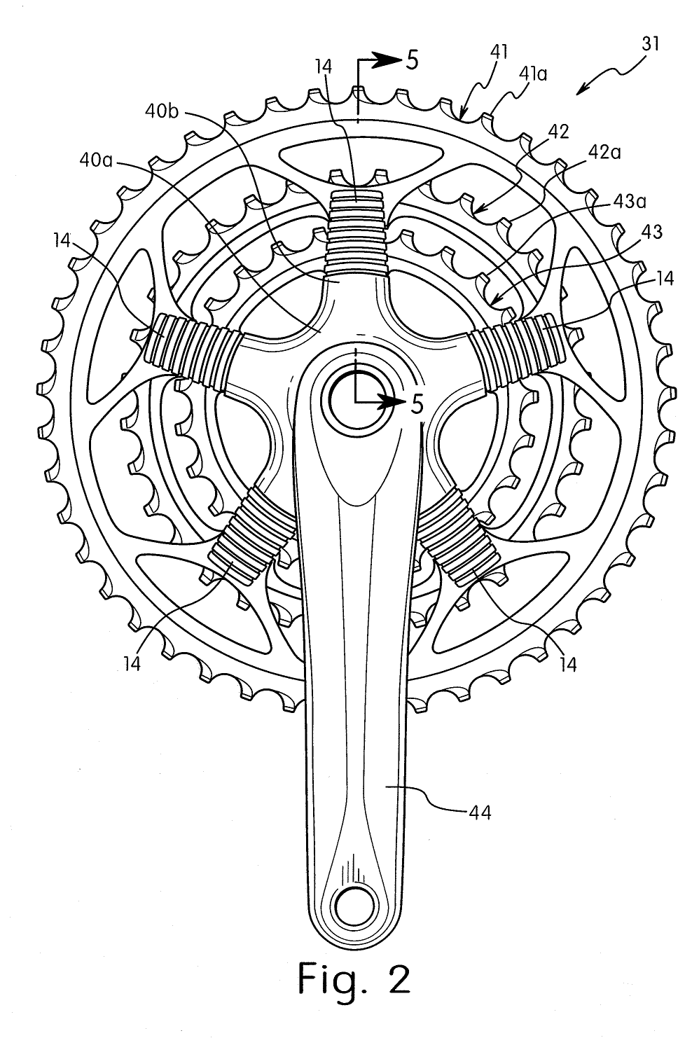

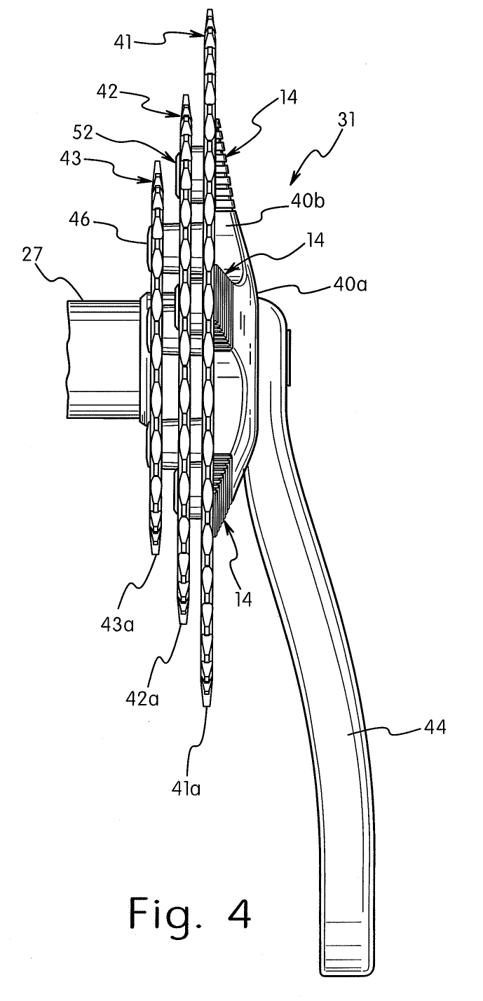

As best seen in FIGS. 2 to 6, the bicycle chain wheel assembly or right crankset 31 basically includes a chainring mounting structure 40, an outer gear or chainring 41, a middle gear or chainring 42, an inner gear or chainring 43 and a right crank arm 44. The chainrings 41 and 43 are fixedly coupled to the chainring mounting structure 40 by a plurality of bicycle chain wheel fastening arrangements 45, while the inner chainring 43 is fixedly coupled to the chainring mounting structure 40 by a plurality of bolts 46.

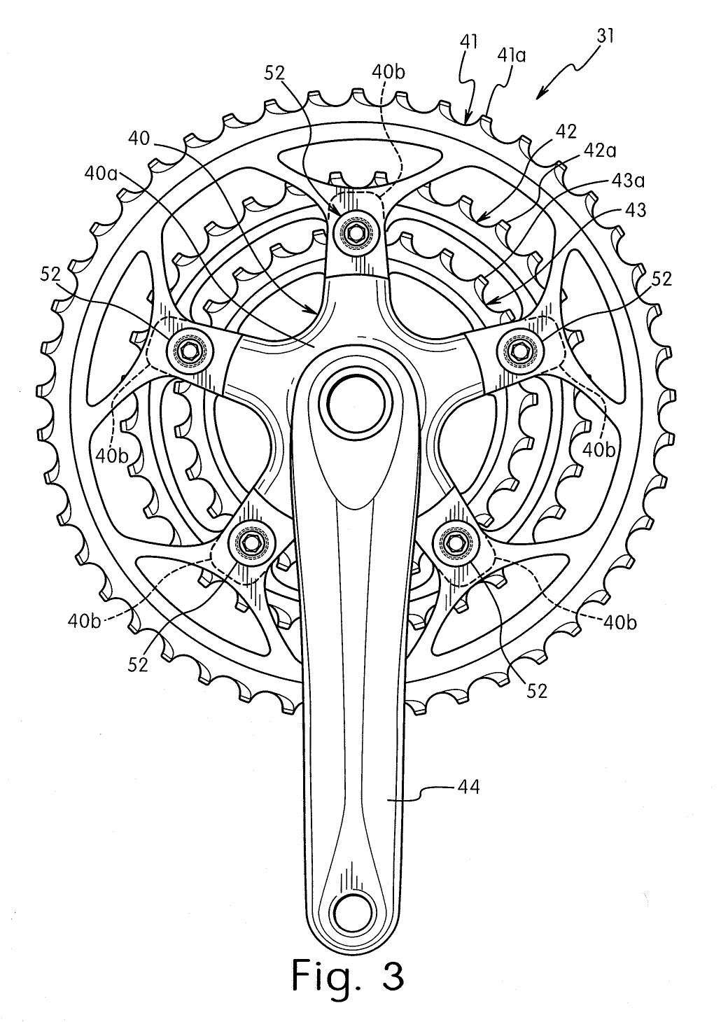

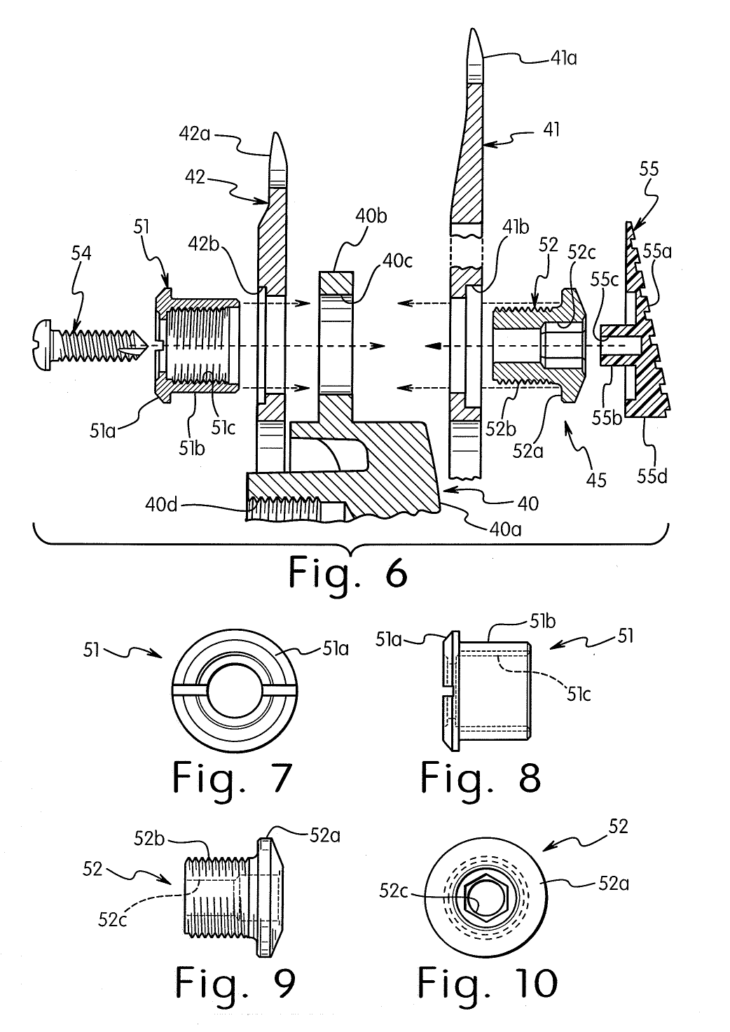

As best seen in FIG. 3, the chainring mounting structure 40 has a center portion 40a and a plurality of connecting or spider arms 40b extending outwardly from the center portion 40a. As best seen in FIG. 6, each of the free ends of the spider arms 40b is provided with a chainring mounting through hole 40c for receiving one of the fastening arrangements 45 to secure the outer and middle chainrings 41 and 42 to the chainring mounting structure 40. The through holes 40c extend from an exterior facing side of the chainring mounting structure 40 to an interior facing side of the chainring mounting structure 40. Thus, the through holes 40c form chainring mounting openings on the exterior facing side of the chainring mounting structure 40. As best seen in FIGS. 5 and 6, the interior facing side of the chainring mounting structure 40 has five threaded bores 40d (only one shown in FIGS. 5 and 6) for threadedly receiving the bolts 46 to secure the inner chainring 43 to the chainring mounting structure 40. The center portion 40a of the chainring mounting structure 40 is non-rotatably fastened on the external periphery of an inner proximal end of the right crank arm 44 by a lock ring 50 as seen in FIG. 5. When the chainrings 41, 42 and 43 and the right crank arm 44 are coupled to the chainring mounting structure 40, a bicycle chain wheel assembly is formed in accordance with the present invention.

Each of the chainrings 41 to 43 are made of a rigid metallic material (e.g. aluminum alloy, titanium, steel or the like) as a one-piece, unitary member. In the illustrated embodiment, the chainrings 41 to 43 are stamped from a sheet metal material. The chainrings 41 to 43 are lined up in consecutive order in the axial direction so that the number of teeth on decreases in the axial direction towards the bicycle frame 16 (i.e. each subsequent inwardly located chainring has a smaller diameter). In particular, the chainrings 41, 42 and 43 have a plurality of outer, middle and inner chainring teeth 41a, 42a and 43a, respectively, with each subsequent inwardly located chainring having fewer circumferentially spaced chainring teeth 41a, 42a and 43a, respectively. The outer chainring 41 is a large-diameter sprocket and is disposed the farthest outward in the axial direction. The middle chainring 42 is a medium-diameter sprocket, and is disposed at an intermediate position in the axial direction. The inner chainring 43 is a small-diameter sprocket with, and is disposed the farthest inward in the axial direction. The chainrings 41, 42 and 43 are also each provided with five circumferential spaced apart mounting holes 41b, 42b and 43b (only one shown in each chainring), respectively, for securing the chainrings 41, 42 and 43 to the chainring mounting structure 40, as discussed below. Since the chainrings 41 to 43 are well known in the art, these structures will not be discussed or illustrated in detail herein.

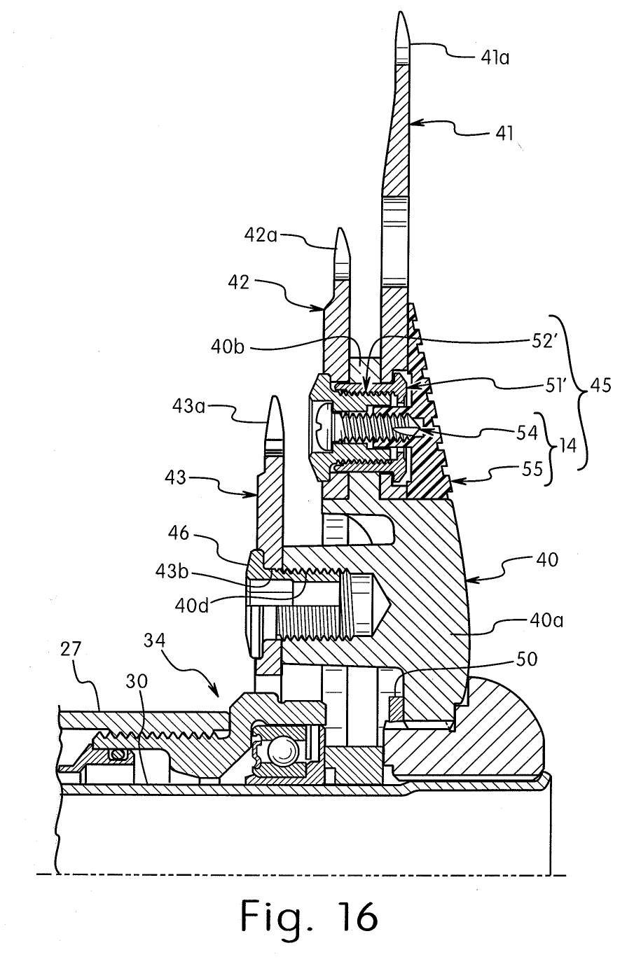

As best seen in FIGS. 5 to 15, each of the bicycle chain wheel fastening arrangements 45 basically includes a fixing nut 51, a fixing bolt 52 and the fastener covering structure 14. The fixing nuts 51 and the fixing bolts 52 are preferably conventional chainring nuts and bolts as illustrated. However, other types of fastening arrangements can be used. For example, if the middle chainring 42 were attached to the interior facing side of the chainring mounting structure 40, then the fixing nuts 51 could be eliminated by threading the fixing nuts 51 directly into threaded openings in the spider arms.

As best seen in FIGS. 5 to 7, each of the fixing nuts 51 includes a head 51a, a shaft 51b and an internally threaded bore 51c extending axially through the head 51a and the shaft 51b. The head 51a is configured with a tool engaging surface such as a slot for receiving a screw driver. The shafts 51b of the fixing nuts 51 are dimensioned to be received through the mounting holes 42b in the middle chainring 42 and into the through holes 40c from the interior facing side of the chainring mounting structure 40, with the heads 51a abutting against the middle chainring 42.

As best seen in FIGS. 5, 6, 9 and 10, each of the fixing bolts 52 includes a head 52a, an externally threaded shaft 52b and an internal passage 52c extending axially through the head 52a and the shaft portion 52b. The internal passage 52c of each of the fixing bolts 52 is provided with a non-circular (hexagon) tool engaging surface adjacent the head 52a for receiving a tool such as an Allen wrench. The externally threaded shafts 52b are dimensioned to be received through the mounting holes 41b in the outer chainring 41 and to thread into the internally threaded bores 51c of the fixing nuts 51 with the heads 52a abutting against the outer chainring 41.

As best seen in FIGS. 5 and 6, the fastener covering structure 14 passes through a part of one of the fasteners (i.e., the fixing nuts 51 and the fixing bolts 52) of the chain wheel fastening arrangements 45. In particular, the fastener covering structure 14 includes a plurality of self-tapping screws 54 and a plurality of non-metallic fastener covers 55, with one of the screws 54 and one of the fastener covers 55 being used with each the fasteners (i.e., the fixing nuts 51 and the fixing bolts 52) of the chain wheel fastening arrangements 45. The fastener covering structure 14 forms a releasable and reinstallable connection such that the fastener covers 55 can be easily removed and reinstalled.

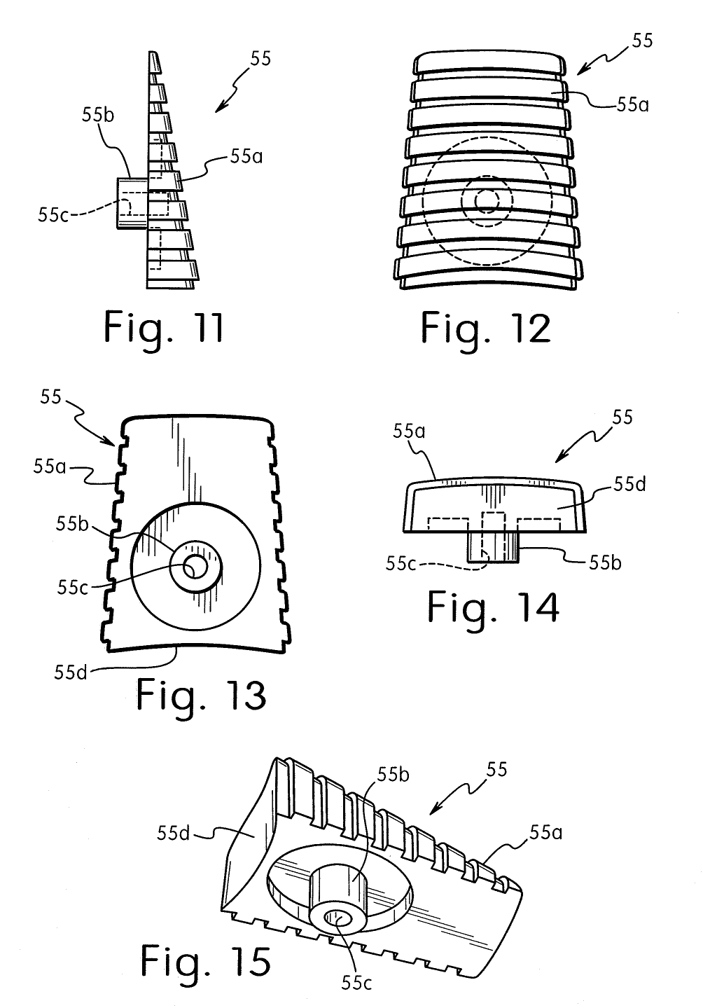

As best seen in FIGS. 11 to 15, the fastener cover 55 has a cover portion 55a and a fastening portion 55b with a screw receiving bore 55c being formed in the fastening portion 55b. The fastener cover 55 is a one-piece unitary member formed of a non-metallic material such as a synthetic resin material that is relatively hard (e.g., polyacetal, polypropylene, or polyamide resin). The synthetic resin material of the fastener cover 55 also preferably has a lower weight (i.e. per unit of volume) than the metal material of the chainrings 41, 42 and 43. Alternatively, the fastening cover 55 may be made of a metallic material, such as iron, aluminum, titanium, or the like. Preferably, each of the cover portions 55a has an exterior surface with a peripheral edge 55d that mates with an edge of the exterior facing side of one of the spider arms 40b to form a smooth non-abrupt transition therebetween.

The self-tapping screw 54 and the fastening portion 55b cooperate together to form a coupling portion of the fastener covering structure 14. Thus, more specifically, the coupling portions of the fastener covering structure 14 include the screws 54 and the screw receiving bores 55c. Each of the self-tapping screws 54 passes through one of the internal bores 52c of the fixing bolts 52 and threadedly engages the fastening portions 55b of the fastener covers 55 such that the cover portions 55a of the fastener covers 55 overlie the heads 52a (i.e., exterior portions) of the fixing bolts 52 to conceal the fixing bolts 52 (i.e., a chainring fastener). Thus, the cover portions 55a of the fastener covering structure 14 overlie the heads 52a (i.e., the exterior portions) of the fixing bolts 52 to conceal the fixing bolts 52 from view when viewed from the exterior facing side of the chainring mounting structure 40.

### Second Embodiment

Referring now to FIG. 16, a bicycle chain wheel fastening arrangement 45′ in accordance with a second embodiment will now be explained. Basically, the bicycle chain wheel fastening arrangement 45′ is used with the bicycle chain wheel of the first embodiment by replacing the bicycle chain wheel fastening arrangement 45 of the first embodiment with the bicycle chain wheel fastening arrangement 45′ of this second embodiment. In view of the similarity between the first and second embodiments, the parts of the second embodiment that are identical to the parts of the first embodiment will be given the same reference numerals as the parts of the first embodiment.

Basically, each of the bicycle chain wheel fastening arrangements 45′ basically includes a modified fixing nut 51′, a modified fixing bolt 52′ and the fastener covering structure 14 of the first embodiment. Thus, the bicycle chain wheel fastening arrangements 45′ of this second embodiment use the self-tapping screws 54 of the first embodiment and the fastener covers 55 of the first embodiment. However, in this second embodiment, the fixing nuts 51′ are located on the exterior facing side of the chainring mounting structure 40, while the fixing bolts 52′ are located on the interior facing side of the chainring mounting structure 40. Thus, the fastener cover 55, in this embodiment, cover the heads of the fixing nuts 51′. Since the descriptions of the parts of the second embodiment are identical to the descriptions of the parts of the first embodiment, except for the locations of the fixing nut 51′ and the fixing bolt 52′, further descriptions of the second embodiment will be omitted for the sake of brevity.

### Third Embodiment

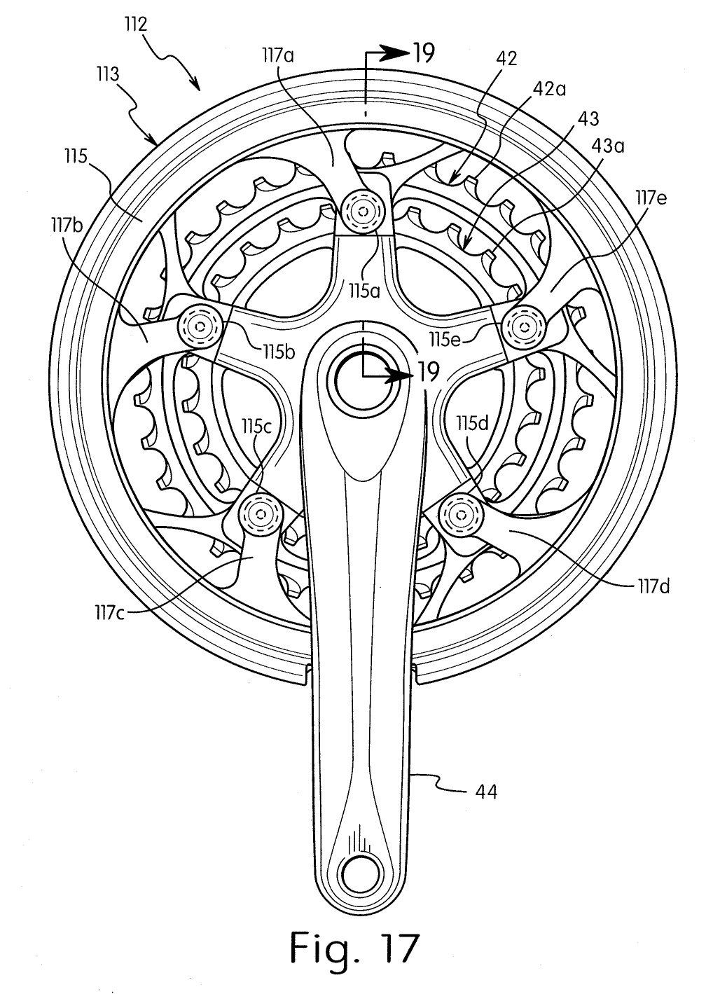

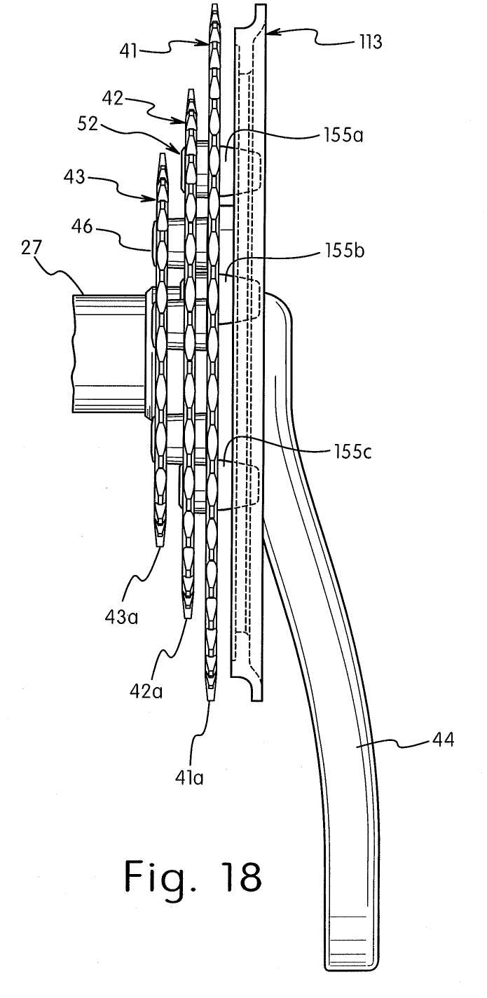

Referring now to FIGS. 17 to 21, a bicycle chain wheel assembly 112 with a chain guard 113 having an integral fastener covering structure 114 is illustrated in accordance with a third embodiment. Basically, the bicycle chain wheel assembly 112 replaces is used with the bicycle chain wheel 12 of the first embodiment. However, the chain guard 113 with the integral fastener covering structure 114 can also be used with the second embodiment as needed and/or desired. In any event, in the illustrated embodiment, the bicycle chain wheel assembly 112 is identical to the bicycle chain wheel 12 of the first embodiment, except that the fastener covering structure 14 of the first embodiment has been replaced with the chain guard 113 having the integral fastener covering structure 114 in this third embodiment. In view of the similarity between the first and third embodiments, the parts of the third embodiment that are identical to the parts of the first embodiment will be given the same reference numerals as the parts of the first embodiment. Thus, only the chain guard 113 will be discussed and illustrated in detail herein.

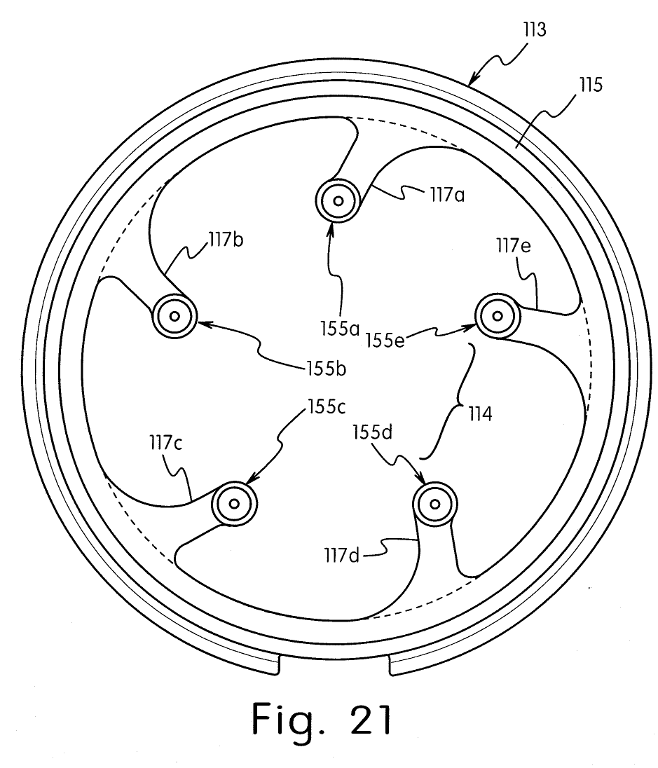

The chain guard 113 is a relatively rigid member that can be constructed of a hard rigid plastic material (as shown) or from a metallic material that is preferably lightweight and rust resistant. The integral fastener covering structure 114 includes a plurality of self-tapping screws 154, a plurality of non-metallic fastener covers 155a to 155e and a plurality of non-metallic spacers 156. The chain guard 113 and the fastener covers 155a to 155e are preferably molded together as a one-piece, unitary member from a hard rigid plastic material. The chain guard 113 includes an annular guard portion 115 and a plurality of connecting portions 117a to 117e. The fastener covers 155a to 155e are integral formed with the connecting portions 117a to 117e such that the annular guard portion 115 is supported on the chainring mounting structure 40 by the screws 154 and the fastener covers 155a to 155e. Thus, as seen in FIG. 21, the fastener covers 155a to 155e are each provided with a blind bore that threadedly receives one of the screws 154.

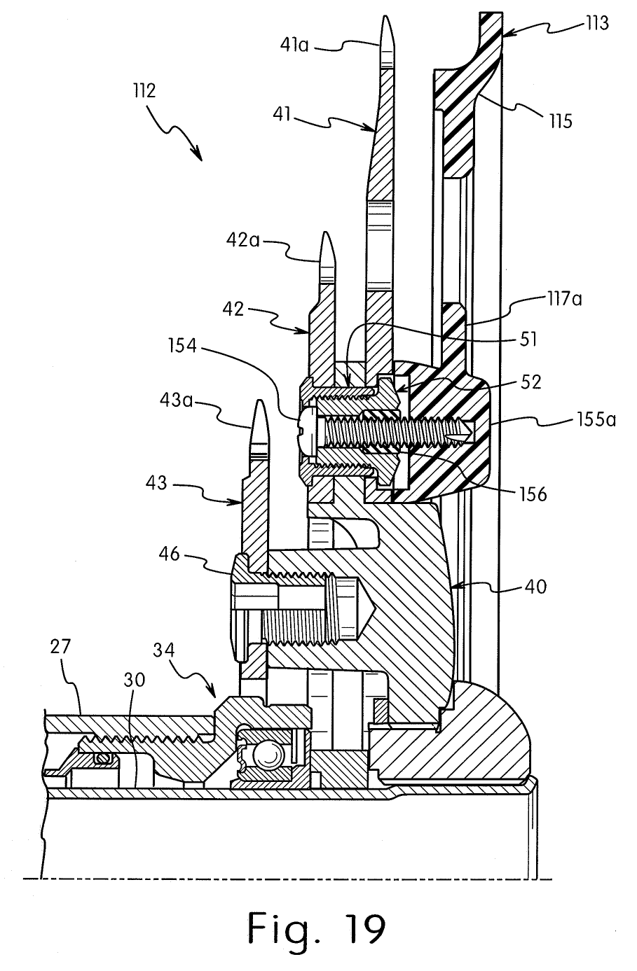

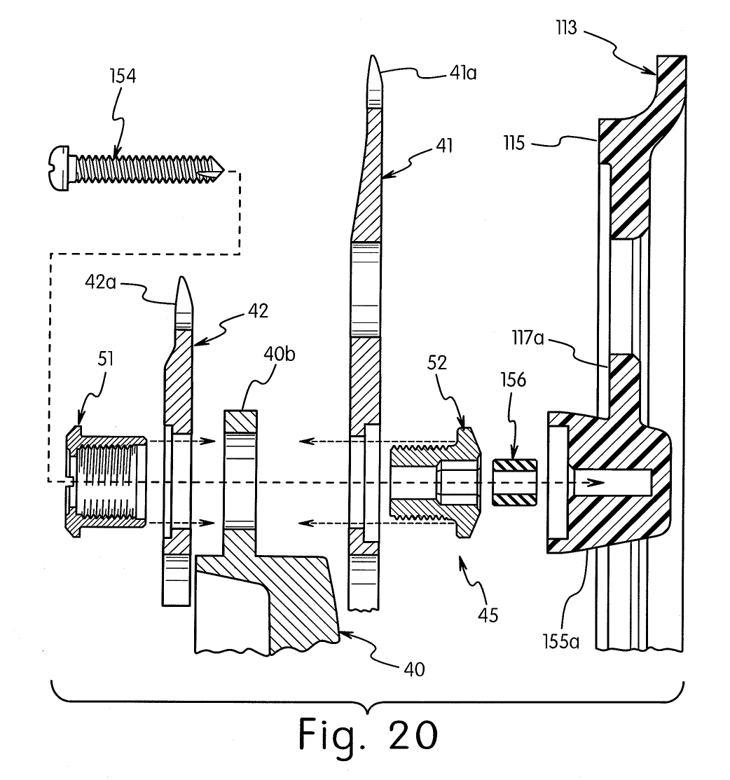

As best seen in FIGS. 19 and 20, the screws 154 of the fastener covering structure 114 passes through a part of one of the fasteners (i.e., the fixing nuts 51 and the fixing bolts 52) of the chain wheel fastening arrangements 45. The spacers 156 are preferably rubber or plastic sleeves that can be used to maintain the screws 154 in fasteners (i.e., the fixing nuts 51 and the fixing bolts 52) of the chain wheel fastening arrangements 45 prior to attaching the chain guard 113 via the fastener covers 155a to 155e. Thus, the fastener covering structure 114 forms a releasable and reinstallable connection such that the chain guard 113 can be easily removed and reinstalled with the fastener covers 155a to 155e overlying the fasteners (i.e., the fixing nuts 51 and the fixing bolts 52) of the chain wheel fastening arrangements 45.

### General Interpretation of Terms

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts. Also as used herein to describe the above embodiment, the following directional terms “forward, rearward, above, downward, vertical, horizontal, below and transverse” as well as any other similar directional terms refer to those directions of a bicycle equipped with the present invention. Accordingly, these terms, as utilized to describe the present invention should be interpreted relative to a bicycle equipped with the present invention. Finally, terms of degree such as “substantially”, “about” and “approximately” as used herein mean a reasonable amount of deviation of the modified term such that the end result is not significantly changed.

While only one embodiment has been chosen to illustrate the present invention, it will be apparent to those skilled in the art from this disclosure that various changes and modifications can be made herein without departing from the scope of the invention as defined in the appended claims. Furthermore, the foregoing descriptions of the embodiments according to the present invention are provided for illustration only, and not for the purpose of limiting the invention as defined by the appended claims and their equivalents.

What is claimed is:

1. A bicycle chain wheel comprising:
a chainring mounting structure including an exterior facing side and an interior facing side with at least one chainring mounting opening on the exterior facing side;
a chainring overlying one of the exterior and interior facing sides of the chainring mounting structure;
a fastener coupled to the at least one chainring mounting opening to secure the chainring to the chainring mounting structure; and
a fastener covering structure overlying an exterior portion of the fastener to conceal the fastener from view when viewed from the exterior facing side of the chainring mounting structure.

2. The bicycle chain wheel according to claim 1, wherein
the fastener covering structure is threadedly attached to part of the fastener.

3. The bicycle chain wheel according to claim 1, wherein
the fastener covering structure includes a coupling portion engaging the fastener, and a cover portion overlying the exterior portion.

4. The bicycle chain wheel according to claim 3, wherein
the coupling portion of the fastener covering structure includes a screw and a screw receiving bore formed in a fastening portion on the cover portion of the fastener covering structure.

5. The bicycle chain wheel according to claim 4, wherein
the screw of the fastener covering structure passes through a part of the fastener.

6. The bicycle chain wheel according to claim 3, wherein
the cover portion is formed of a non-metallic material.

7. The bicycle chain wheel according to claim 3, wherein
the cover portion has an exterior surface with a peripheral edge that mates with an edge of the exterior facing side to form a smooth non-abrupt transition therebetween.

8. The bicycle chain wheel according to claim 1, wherein
the chainring mounting structure includes a center portion and a plurality of spider arms extending outwardly from the center portion with the at least one chainring mounting opening including a plurality of through holes formed on the spider arms;
the fastener includes a plurality of nuts and bolts with one pair of the nuts and bolts being receiving in each one of the through holes; and
the fastener covering structure includes a plurality of screws, and a plurality of cover portions with one pair of the screws and cover portions being secured to one of the pairs of the nuts and bolts.

9. The bicycle chain wheel according to claim 1, wherein
the fastener includes a fixing nut including an internally threaded bore, and a fixing bolt including an externally threaded shaft with an axially extending internal passage that coaxially aligns with the internally threaded bore of the fixing nut when the externally threaded shaft of the fixing bolt is threaded in the internally threaded bore of the fixing nut.

10. The bicycle chain wheel according to claim 9, wherein
the fastener covering structure includes a coupling portion engaging one of the fixing nut and the fixing bolt, and a cover portion overlying the exterior portion formed by one of the fixing nut and the fixing bolt.

11. The bicycle chain wheel according to claim 10, wherein
the coupling portion of the fastener covering structure includes a screw and a screw receiving bore formed in a fastening portion on the cover portion of the fastener covering structure.

12. The bicycle chain wheel according to claim 11, wherein
the screw of the fastener covering structure pass through the internal passage of the fixing bolt.

13. The bicycle chain wheel according to claim 11, wherein
the cover portion is formed of a non-metallic material.

14. A bicycle chain wheel fastening arrangement comprising:
a fixing nut including an internally threaded bore;
a fixing bolt including an externally threaded shaft with an axially extending internal passage that coaxially aligns with the internally threaded bore of the fixing nut when the externally threaded shaft of the fixing bolt is threaded in the internally threaded bore of the fixing nut;
a fastener covering structure including coupling portion engaging one of the fixing nut and the fixing bolt, and a cover portion overlying an exterior portion of one of the fixing nut and the fixing bolt to conceal the fastener.

15. The bicycle chain wheel fastening arrangement according to claim 14, wherein
the fastener covering structure is threadedly attached to the fastener.

16. The bicycle chain wheel fastening arrangement according to claim 14, wherein
the coupling portion of the fastener covering structure includes a screw and a screw receiving bore formed in a fastening portion on the cover portion of the fastener covering structure.

17. The bicycle chain wheel fastening arrangement according to claim 16, wherein
the screw of the fastener covering structure has a head that engages one of the fixing nut and the fixing bolt.

18. The bicycle chain wheel fastening arrangement according to claim 16, wherein
the screw of the fastener covering structure passes through the internal passage of the fixing bolt.

19. The bicycle chain wheel fastening arrangement according to claim 14, wherein
the cover portion is formed of a non-metallic material.
